(19) United States
(12) Patent Application Publication
(10) Pub. No.: US 2008/0258480 A1
(43) Pub. Date: Oct. 23, 2008

(54) Slide door hold open

(75) Inventors: Richard A. Seiss, Spartanburg, SC (US); Harry A. Brancheau, Inman, SC (US)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Carrier Corporation, Farmington, CT (US)

(21) Appl. No.: 11/900,097

(22) Filed: Sep. 10, 2007

Related U.S. Application Data
(60) Provisional application No. 60/925,448, filed on Apr. 20, 2007.

(51) Int. Cl. E05C 17/48; G05G 5/06

(52) U.S. Cl. 292/277; 74/527

(57) ABSTRACT

A door latch system is positioned within a slidable door system. The slidable door system includes at least one track and a door positioned within the track. The door latch system includes an engagement member and a spring form mountable within the slidable door system. The spring form is movable between a relaxed position and an actuated position and is configured to be out of a path of the engagement member when the spring form is in the relaxed position and to be engagable with the engagement member when the spring form is in the actuated position. One of the engagement member and the spring form is mounted to the door and the other is mounted to the track.

### REFERENCE TO COPENDING APPLICATION

This application claims priority from provisional application Ser. No. 60/925,448, filed Apr. 20, 2007.

### BACKGROUND

The present invention relates to the field of door latches. More particularly, the present invention relates to a positive actuation door latch.

Sliding doors, such as those used in refrigeration units, are typically positioned within a set of tracks that maintain the door in a vertical, upright position. The tracks and door are held within a frame which provides stability for the tracks. The door is set within a top track and a bottom track and can slide back and forth within the tracks by a plurality of rollers or wheels that guide the door. The door is slidable between an open position and a closed position. Normally, the door is moved to the open position when an operator slides the door in a first direction so that the operator can place an item into, or remove an item from, the refrigeration unit. Once the force from the operator pulling the door in the first direction is removed, the door automatically slides back in a second direction through a drive mechanism. The drive mechanism may be either spring driven or gravity driven.

In some circumstances, it may be desirable to maintain the door in the open position for an extended period of time, for example, when an operator is stocking the refrigeration unit, or when the refrigeration unit is otherwise being serviced. When the drive mechanism is spring driven, a pin may be used to engage the wheels to prevent the door from sliding within the tracks. When the door is pulled open a certain distance past the pin, the pin is actuated within the track and automatically obstructs the track, propping the door open. However, one of the potential problems with this method is that a consumer may open the door to the distance at which the pin automatically engages the door, and then may walk away from the door without disengaging the pin. The door would then be inadvertently left in the open position, allowing the items within the refrigeration unit to become warm and causing the refrigeration unit to expend excess energy trying to maintain the temperature of the refrigeration unit. In addition, the pin is not designed to be robust, allowing the door to close if even lightly tapped. This is not an ideal condition for a stocker or service worker.

When the drive mechanism is gravity driven, a latch may be installed in the frame that may be actuated to provide support for a weight so that the weight does not drop and pull the door to the closed position. However, this method requires the operator to physically reach into the frame to engage the latch. Depending on the location of the latch within the frame, this may require the operator to awkwardly reach into the frame and engage the latch.

There is, therefore, a need in the art for a robust and positively actuated door latch.

### SUMMARY

A door latch system is positioned within a slidable door system. The slidable door system includes at least one track and a door positioned within the track. The door latch system includes an engagement member and a spring form mountable within the slidable door system. The spring form is movable between a relaxed position and an actuated position and is configured to be out of a path of the engagement member when the spring form is in the relaxed position and to be engagable with the engagement member when the spring form is in the actuated position. One of the engagement member and the spring form is mounted to the door and the other is mounted to the track.

### BRIEF DESCRIPTION OF THE DRAWINGS

FIG. 1A is a perspective view of a spring form in a relaxed position.

FIG. 1B is a side view of the spring form in a relaxed position

FIG. 1C is a top view of the spring form in a relaxed position.

FIG. 1D is a front view of the spring form in a relaxed position.

FIG. 1E is a perspective view of the spring form in an actuated position.

FIG. 2A is a perspective view of a clip.

FIG. 2B is a side view of the clip.

FIG. 2C is a top view of the clip.

FIG. 3 is a perspective view of the spring form in the actuated position and the clip engaging the spring form.

FIG. 4 is a perspective view of a door system.

FIG. 5A is a partial perspective view of a door positioned on a bottom track of the door system.

FIG. 5B is a partial cutaway view of the door positioned on the bottom track of the door system.

FIG. 6 is a cross-sectional view of the door taken at lines 6-6 of FIG. 4 positioned on a top track of the door system.

FIG. 7A is an enlarged, partial side view of the spring form in the relaxed position mounted to the top track of the door system.

FIG. 7B is an enlarged, partial side view of the spring form mounted in the actuated position to the top track of the door system and engaging the clip.

### DETAILED DESCRIPTION

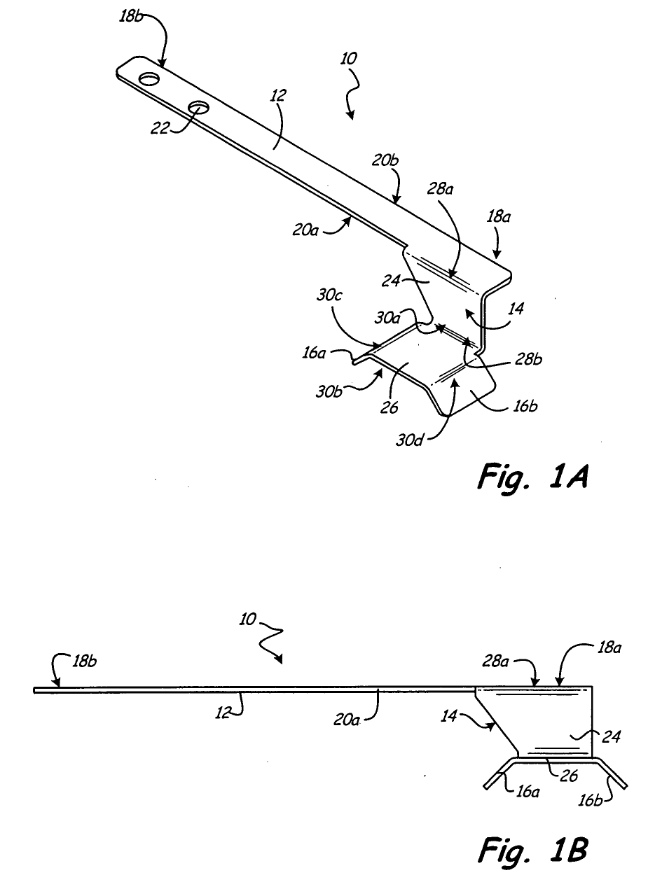

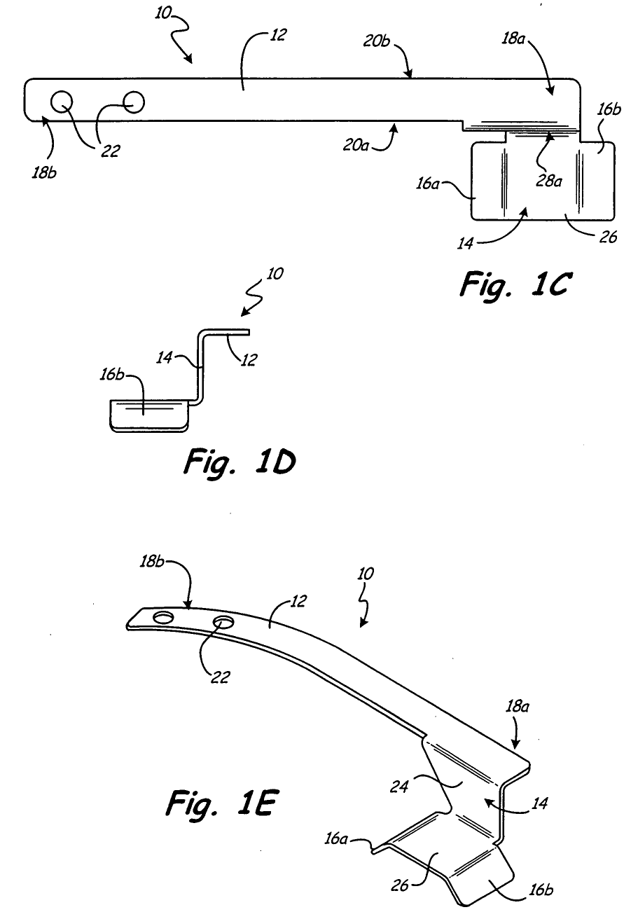

1A, 1B, 1C, and 1D show a perspective view, a side view, a top view, and a front view of spring form 10, respectively, in a relaxed position. FIG. 1E shows a perspective view of spring form 10 in an actuated position. FIGS. 1A-1E will be discussed in conjunction with one another. Spring form 10 generally includes elongated arm or beam 12, protrusion or latch 14 extending substantially normally from elongated arm 12, and a pair of wings 16a and 16b (wings 16) extending from protrusion 14. As shown, spring form 10 is manufactured as an integrated piece. Alternatively, elongated arm 12, protrusion 14, and wings 16 may be formed separately and attached to one another by any method known in the art, including, but not limited to: welding and an adhesive. In an exemplary embodiment, elongated arm 12, protrusion 14, and wings 16 of spring form 10 may be formed of materials including, but not limited to: spring steel, plastic, elastomers, or other flexible metals.

Elongated arm 12 is substantially flat and linear and is movable between a relaxed position (shown in FIG. 1A) and an actuated position (shown in FIG. 1E). Elongated arm 12 includes first end 18a, second end 18b, first side 20a, and second side 20b and exhibits a degree of flexibility such that elongated arm 12 bends when pressure is applied to first end 18a. When the pressure is released from first end 18a, elongated arm 12 returns to its original, or relaxed, position. Second end 18b of elongated arm 12 has bolt holes 22 for mounting elongated arm 12 to a stationary structure, such as a door frame. In an exemplary embodiment, elongated arm 12 is between approximately 3 inches and approximately 4 inches long, between approximately 0.2 inches and approximately 0.3 inches wide, and between approximately 0.03 and approximately 0.04 inches thick. However, elongated arm 12 may have any length and thickness as long as elongated arm 12 is flexible. Although FIGS. 1A and 1B depict elongated arm 12 as having two bolt holes 22, elongated arm 12 may have any number of bolt holes 22 without departing from the scope of the present invention.

Protrusion 14 is connected to first side 20a of elongated arm 12 and generally includes first portion 24 and second portion 26. First portion 24 has first edge 28a and second edge 28b. Second portion 26 has first edge 30a, second edge 30b, third edge 30c, and fourth edge 30d. First edge 28a of first portion 24 is connected substantially normally to first side 20a of elongated arm 12 proximate first end 18a of elongated arm 12. First edge 30a of second portion 26 is connected substantially normally to second edge 28b of first portion 24. In an exemplary embodiment, first portion 24 is tapered between first edge 28a and second edge 28b; is between approximately 0.4 inches and approximately 0.6 inches long; and is between approximately 0.5 inches and approximately 0.8 inches wide. Second portion 26 is between approximately 0.6 inches and approximately 0.7 inches long and between approximately 0.4 inches and approximately 0.6 inches wide.

Wings 16 of spring form 10 extend from second portion 26 of protrusion 14. First wing 16a extends from third edge 30c of second portion 26 and second wing 16b extends from fourth edge 30d of second portion 26. Wings 16 extend from protrusion 14 at an angle. In an exemplary embodiment, wings 14 extend from protrusion 14 at an angle of approximately 45 degrees. In another exemplary embodiment, wings 16a and 16b are each between approximately 0.2 inches and approximately 0.3 inches long and between approximately 0.5 inches and approximately 0.6 inches wide. Although FIGS. 1A and 1B depict spring form 10 as having two wings 16, spring form 10 may include only one wing 16 without departing from the intended scope of the present invention.

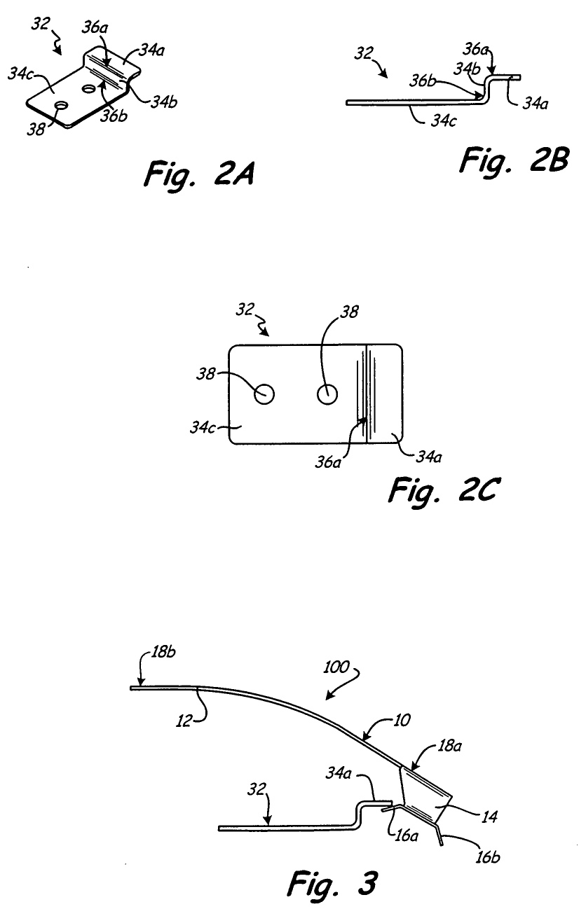

FIG. 2A shows a perspective view of clip 32, FIG. 2B shows a side view of clip 32, and FIG. 2C shows a top view of clip 32. FIGS. 2A-2C will be discussed in conjunction with one another. Clip 32 has first end portion 34a, center portion 34b, and second end portion 34c. Center portion 34b has first edge 36a and second edge 36b. First end portion 34a is connected substantially perpendicularly to first edge 36a of center portion 34b and second end portion 34c is connected substantially perpendicularly to second edge 36b of center portion 34b. As can be seen in FIGS. 2A and 2B, second end portion 34c is longer than first end portion 34a. Second portion 34c also includes bolt holes 38 for mounting clip 32 to an object, such as a door. In an exemplary embodiment, first end portion 34a is between approximately 0.3 inches and approximately 0.5 inches long and between approximately 0.6 inches and approximately 0.8 inches wide. Center portion 34b is between approximately 0.1 inches and approximately 0.3 inches long and between approximately 0.6 inches and approximately 0.8 inches wide. Second end portion 34c is between approximately 0.9 inches and approximately 1 inch long and between approximately 0.6 inches and approximately 0.8 inches wide. As shown, clip 32 is manufactured as an integrated piece, and is formed of, for example, steel. Alternatively, first end portion 34a, center portion 34b, and second end portion 34c of clip 32 may be attached to one another by any method known in the art, including, but not limited to: welding and an adhesive. Clip 32 may be formed of any suitable material, including, but not limited to: steel, plastic, elastomers, or other metal. In addition, although clip 32 is discussed as being bolted to an object, clip 32 may be connected to the object by any means known in the art, including, for example, being snapped onto the object.

FIG. 3 shows a perspective view of door latch system 100 including spring form 10 in the actuated position and clip 32 engaging spring form 10. In operation, second end 18b of elongated arm 12 of spring form 10 is mounted to a stationary structure, and clip 32 is positioned relative to spring form 10 such that clip 12 is engagable with spring form 10. When spring form 10 is to be used, elongated arm 12 of spring form 10 is first actuated by exerting force on second wing 16b to bend first end 18a of elongated arm 12. Because second end 18b of elongated arm 12 is held in place and because elongated arm 12 is designed to be flexible, first end 18a is allowed to bend when enough force is exerted on second wing 16b. Although elongated arm 12 is discussed as bending due to force exerted on second wing 16b, elongated arm 12 may be bent by exerting force anywhere at first end 18a of elongated arm 12 or any element attached to first end 18a of elongated arm 12.

To maintain spring form 10 in the actuated position, pressure must be constantly exerted on second wing 16b, either manually or by clip 32. When spring form 10 is actuated, spring form 10 is in a loaded position and exerts its own force to return to the relaxed position (shown in FIG. 1). To maintain spring form 10 in the actuated position by clip 32, first portion 34a of clip 32 engages first wing 16a of spring form 10. In practice, clip 32 is mounted to a slidable structure, such as a slidable door, which slides towards spring form 10 until it engages spring form 10. As long as first portion 34a of clip 12 is engaging first wing 16a of spring form 10, spring form 10 will remain in the actuated position.

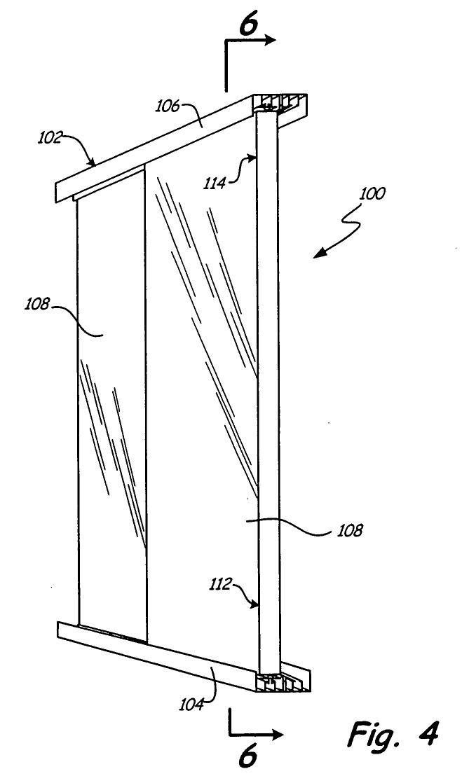

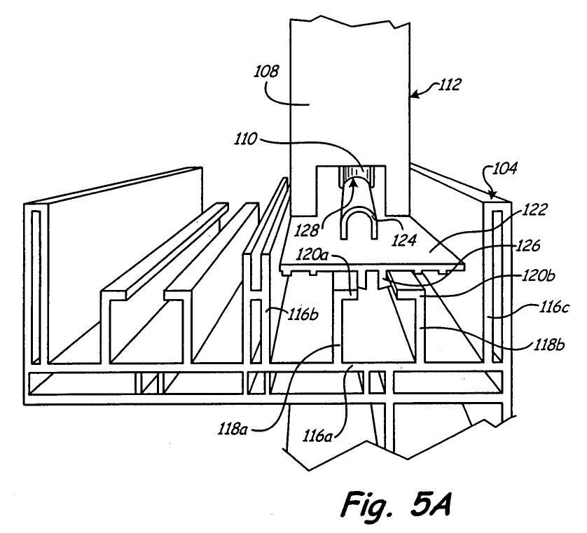

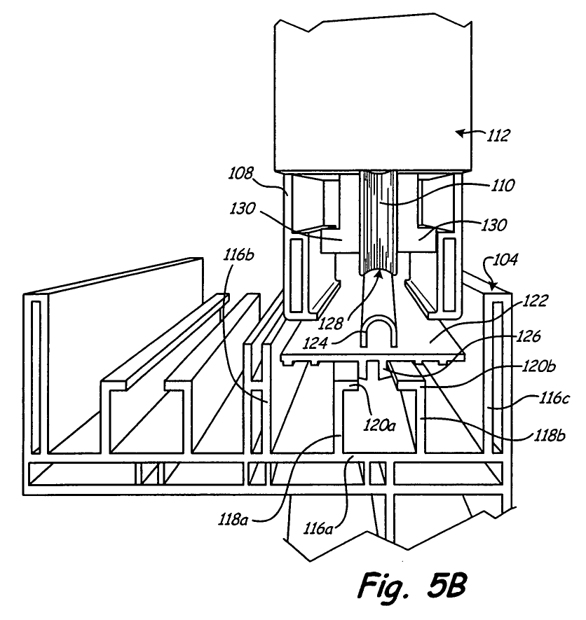

FIG. 4 shows a perspective view of door latch system 100 mounted to frame 102. Frame 102 generally includes bottom track 104, top track 106, door 108, and rollers 110 (shown in FIG. 5B). Bottom and top tracks 104 and 106 maintain door 108 within frame 102. Door 108 has a bottom end 112 positioned on bottom track 104 and a top end 114 positioned within top track 106. Rollers 110 are connected to door 108 and are positioned on bottom track 104 to allow door 108 to slide between an open position and a closed position within frame 102. When door 108 is in the open position, door 108 is positioned within frame 102 such that there is an opening in frame 102, allowing a person to reach through the opening into frame 102 and access an item positioned within frame 102. When door 108 is in the closed position, door 108 is positioned within frame 102 such that door 108 completely blocks the path into frame 102. Spring form 10 is mounted within top track 106 at approximately the center of frame 102. Clip 32 is mounted at top end 114 of door 108.

FIG. 5A shows a partial perspective view of bottom end 112 of door 108 positioned on bottom track 104. FIG. 5B shows a partial cutaway view of door 108 positioned on bottom track 104 and roller 110. FIGS. 5A and 5B will be discussed in conjunction with one another. Bottom track 104 is U-shaped and generally includes main wall 116a, first side wall 116b, second side wall 116c, first channel wall 118a, and second channel wall 118b. First side wall 116b, second side wall 116c, first channel wall 118a, and second channel wall 118b are attached substantially normally to main wall 116a and are spaced apart from one another. First channel wall 118a and second channel wall 118b are L-shaped and are positioned between first side wall 116b and second side wall 116c. First and second channel walls 118a and 118b are shorter than first and second side walls 116b and 116c and have a perpendicular bend at an end spaced from main wall 116a to form first and second support surfaces 120a and 120b, respectively. Main wall 116a of bottom track 104 has a width slightly greater than a width of bottom end 112 of door 108, which slides on top of bottom track 104 by support plate 122 and rollers 110.

Support plate 122 is positioned within bottom track 104 between first side wall 116b and second side wall 116c and sits on support surfaces 120a and 120b. Support plate 122 includes semi-cylindrical rail 124 that runs the length of support plate 122 and extends away from main plate 116a. Semi-cylindrical rail 124 functions to guide roller 110 along the length of bottom track 104. Support plate 122 may include projections 126 that extend toward main wall 116a to help maintain support plate 122 within bottom track 104 and between first and second channel walls 118a and 118b. However, because support plate 122 extends the length and width of main wall 116a, projections 126 are optional.

Rollers 110 have a concave shape and include semi-circular cut-out 128 along the perimeter of each of rollers 110. Cut-out 128 of rollers 110 engages semi-cylindrical rail 124 of support plate 122 and uses semi-cylindrical rail 124 as a track for moving door 108 between the open and closed positions. Door 108 is connected to rollers 110 by connector 130, which is connected to bottom end 112 of door 108. Bottom end 112 of door 108 thus sits on rollers 110 and housing 130. Rollers 110 and connector 130 slide door 108 between the open and closed positions within frame 102 as rollers 110 roll along semi-cylindrical rail 124. Although rollers 110 are discussed as being connected to door 108 by connector 130, rollers 110 may be connected to door 108 by any means known in the art without departing from the intended scope of the present invention. In addition, although FIG. 5B depicts only one roller 110, there are a plurality of rollers 110 positioned below door 108 to guide door 108 within bottom track 104.

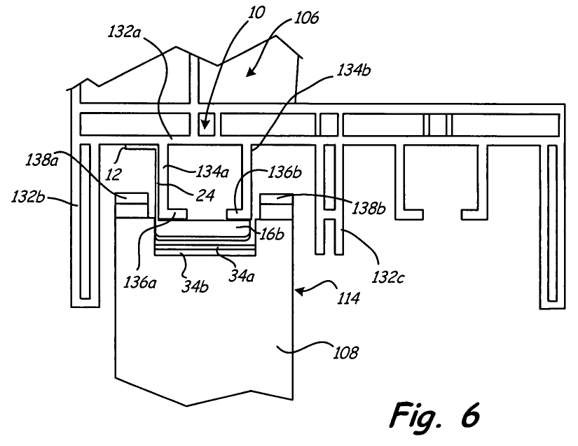

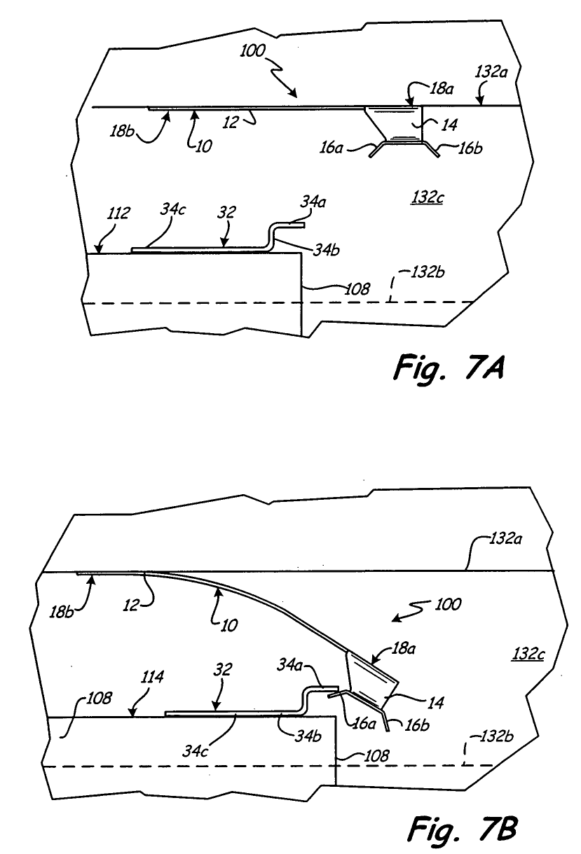

FIG. 6 shows a cross-sectional view of top end 114 of door 108 taken at lines 6-6 of FIG. 4 positioned within top track 106. FIG. 7A shows an enlarged, partial side view of door latch system 100 with spring form 10 in the relaxed position mounted to top track 106 of frame 102. Top track 106 is U-shaped and generally includes main wall 132a, first side wall 132b, second side wall 132c, first channel wall 134a, and second channel wall 134b. First side wall 132b, second side wall 132c, first channel wall 134a, and second channel wall 134b are attached substantially normally to main wall 132a and are spaced apart from one another. First channel wall 134a and second channel wall 134b are L-shaped and are positioned between first side wall 132b and second side wall 132c. First channel wall 134a and second channel wall are shorter than first and second side walls 132b and 132c and have a perpendicular bend at an end spaced from main wall 132a to form first and second support surfaces 136a and 136b, respectively. Main wall 132a of top track 106 has a width slightly greater than a width of top end 114 of door 108, which slides between first and second side walls 132b and 132c of top track 106.

Top end 114 of door 108 includes first side protrusion 138a and second side protrusion 138b that hold door 108 upright within frame 102. First side protrusion 138a extends from top end 114 of door 108 between first side wall 132b and first channel wall 134a and second side protrusion 138b extends from top end 114 of door 108 between second side wall 132c and second channel wall 134b. As door 108 slides between the open position and the closed position within frame 102, top end 114 of door 108 is guided by protrusions 138a and 138b.

Spring form 10 is mounted to main wall 132a of top track 106 between first side wall 132b and first channel wall 134a. Elongated arm 12 of spring form 10 is mounted to main wall 132a of top track 106 at bolt holes 22 (shown in FIGS. 1A and 1C) in second end 18b of elongated arm 12. When spring form 10 is in the relaxed position, elongated arm 12 lies substantially flat against main wall 132a. First portion 24 of spring form 10 extends between first side protrusion 138a of door 108 and first channel wall 134a such that wings 16 of spring form 10 are positioned directly over door 108. Because top end 114 of door 108 is spaced from main wall 132a, top end 114 of door 108 has sufficient room to pass beneath spring form 10 without contacting spring form 10. Although FIG. 6 depicts spring form 10 as being mounted between first channel wall 132b and first channel wall 134a, spring form 20 may also be mounted between second channel wall 134b and second side wall 132b, as long as wings 16 are positioned over door 108, without departing from the intended scope of the invention.

Clip 32 is mounted to top end 114 of door 108 by bolt holes 38 (shown in FIGS. 2A and 2C) in second end portion 34c of clip 32. Clip 32 is mounted to door 108 such that first end portion 34a is engagable with first wing 16a of spring form 10 when spring form 10 is actuated. However, when spring form 10 is in the relaxed position, protrusion 14 and wings 16 of spring form 10 sit within top track 106 such that when door 108 slides within frame 102, spring form 10 does not obstruct the path of door 108.

FIG. 7B shows an enlarged, partial side view of door latch system 100 with spring form 10 in the actuated position mounted to top track 106 and engaging clip 32. When it is desired to maintain door 108 in an open position for an extended period of time, door 108 is first slid to the open position beyond spring form 10. Once door 108 is past spring form 10, spring form 10 is actuated by applying a downward force on second wing 16b of spring form 10 such that first end 18a of elongated arm 12, protrusion 14, and wings 16 bend away from second end 18b of elongated arm 12 and main wall 132a of top track 106. Door 108 is then released so that clip 32 moves into engagement with spring form 10.

When spring form 10 is in the actuated position, protrusion 14 and wings 16 of spring form 10 are in the path of door 108. As door 108 approaches actuated spring form 10, clip 32 mounted on top end 114 of door 108 is aligned to engage first wing 16a. When door 108 reaches spring form 10, the bottom surface of first portion 34a of clip 32 slides over first wing 16a until first wing 16a abuts center portion 34b of clip 32. Once first wing 16a abuts center portion 34b of clip 32, spring form 10 is locked in the actuated position and no longer has to be held in the actuated position manually. When spring form 10 is engaged with clip 32, spring form 10 and clip 32 provide enough resistance to maintain door 108 in the open position and spring form 10 no longer has to be held in the actuated position manually. Door 108 will remain in the open position as long as clip 32 is engaging spring form 10.

When it is desired to slide door 108 to the closed position, door 108 is slid back towards the open position until first wing 16a of spring form 10 disengages from clip 32. Once first portion 34a of clip 32 no longer engages first wing 16a, spring form 10 is released and allowed to move back to the relaxed position (shown in FIGS. 6 and 7A). As previously mentioned, when spring form 10 is in the relaxed position, elongated arm 12 is flush with main wall 132a of top track 106 and holds protrusion 14 and wings 16 of spring form 10 above the path of top end 114 of door 108. Door 108 is thus allowed to slide past spring form 10 without obstruction.

It should be noted that although spring form 10 is depicted in FIGS. 6, 7A, and 7B as being mounted to top track 106, and clip 32 is depicted in FIGS. 6, 7A, and 7B as being mounted to top end 114 of door 108, spring form 10 and clip 32 may be mounted to bottom track 104 and bottom end 112 of door, respectively, without departing from the intended scope of the present invention. In addition, although spring form 10 is discussed as being mounted to top track 106 (or bottom track 104) and clip 32 is discussed as being mounted to door 108, their positions may be reversed with spring form 10 being mounted to door 108 and clip 32 being mounted to top track 106 (or bottom track 104) without departing from the intended scope of the present invention. Furthermore, although door latch system 100 is discussed as including clip 32, in an alternative embodiment, door latch system 100 does not include clip 32, and spring form 10 is maintained in the open position by engaging another engagement member. For example, if spring form 10 is mounted to top track 106 or bottom track 104, spring form 10 may engage a protrusion formed in, or mounted on, door 108. If spring form 10 is mounted to door 108, spring form 10 may engage a protrusion mounted to top or bottom track 106 or 104.

The door latch system includes a spring form and a clip. The spring form is mounted to a track and the clip is mounted to a top end of a door positioned within the track. The spring form includes an elongated body, a protrusion, and a pair of wings. The protrusion extends perpendicularly from a first end of the elongated body, and the pair of wings extend perpendicularly from the protrusion. The spring form is movable between a relaxed position and an actuated position. When the spring form is in the relaxed position, the elongated body is flush with the track and does not obstruct the path of the door and the clip within the track. When the spring form is in the actuated position, force is applied to one of the wings of the spring form to bend the first end of the elongated body away from the second end of the elongated body, which is mounted to the track. As the door slides towards the spring form, the clip on top of the door engages the wing of the protrusion of the spring form. When the clip engages the spring form, the spring form and clip function as a latch to maintain the door in the open position.

The terminology used herein is for the purpose of description, not limitation. Specific structural and functional details disclosed herein are not to be interpreted as limiting, but merely as bases for teaching one skilled in the art to variously employ the present invention. Although the present invention has been described with reference to preferred embodiments, workers skilled in the art will recognize that changes may be made in form and detail without departing from the spirit and scope of the invention.

1. A door latch system positioned within a slidable door system, wherein the slidable door system includes at least one track and a door positioned within the track, the door latch system comprising:
an engagement member mountable within the slidable door system; and
a spring form mountable within the slidable door system, wherein the spring form is movable between a relaxed position and an actuated position, wherein the spring form is configured to be out of a path of the engagement member when the spring form is in the relaxed position, and to be engagable with the engagement member when the spring form is in the actuated position;
wherein one of the engagement member and the spring form is mounted to the track and the other is mounted to the door.

2. The door latch system of claim 1, wherein the engagement member comprises a clip.

3. The door latch system of claim 2, wherein the spring form is mountable to the track and the clip is mountable to the door, and wherein the clip is engagable with the spring form when the spring form is in the actuated position.

4. The door latch system of claim 2, wherein the clip is mountable to the track and the spring form is mountable to the door, and wherein the clip is engagable with the spring form when the spring form is in the actuated position.

5. The door latch system of claim 2, wherein the clip has a first end portion, a center portion, and a second end portion, wherein the center portion has a first edge and a second edge, and wherein the first end portion is connected substantially perpendicularly to the first edge of the center portion and the second end portion is connected substantially perpendicularly to the second edge of the center portion.

6. The door latch system of claim 1, wherein the spring form comprises:
a flat, elongated arm having a first end and a second end;
a latch extending substantially normally from the first end of the flat, elongated arm; and
a pair of wings extending from the latch.

7. The door latch system of claim 6, wherein the latch has a first portion and a second portion, wherein the first portion has a first edge and a second edge and the second portion has a first edge and a second edge, and wherein the second edge of the first portion is connected substantially perpendicularly to the first edge of the second portion.

8. The door latch system of claim 7, wherein the pair of wings extend from the latch at an angle.

9. The door latch system of claim 8, wherein the pair of wings extend from the latch at an angle of about 45 degrees.

10. A method of maintaining a slidable door in an open position within a frame, the method comprising:
actuating a spring form positioned within the frame from a relaxed position in which the spring form is out of a path of an engagement member, to an actuated position in which the spring form is positioned in the path of the engagement member; and
engaging the spring form with the engagement member;
wherein one of the spring form and the engagement member is mounted to the slidable door and the other is mounted within the frame.

11. The method of claim 10, wherein the spring form comprises:
a flat, elongated arm having a first end and a second end;
a latch extending substantially normally from the first end of the flat, elongated arm; and
at least one wing extending from the latch.

12. The method of claim 11, wherein the latch has a first portion and a second portion, wherein the first portion has a first edge and a second edge and the second portion has a first edge and a second edge, and wherein the second edge of the first portion is connected substantially perpendicularly to the first edge of the second portion.

13. The method of claim 10, wherein engaging the spring form with the engagement member comprises engaging the spring form with a clip.

14. The method of claim 13, wherein the clip has a first end portion, a center portion, and a second end portion, wherein the center portion has a first edge and a second edge, and wherein the first end portion is substantially perpendicularly connected to the first edge of the center portion and the second end portion is substantially perpendicularly connected to the second edge of the center portion.

15. The method of claim 14, wherein engaging the spring form with the clip comprises engaging the one wing of the spring form with the first end portion of the clip.

16. The method of claim 11, wherein actuating the spring form comprises applying force to the flat, elongated arm of the spring form.

17. A system for maintaining a door in an open position within a track, the system comprising:
a spring form having an elongated beam, a latch extending substantially normally from the elongated beam, and at least one wing extending from the latch, wherein the spring form is mounted to the track proximate the door.

18. The door latch system of claim 17, wherein the latch has a first portion and a second portion, wherein the first portion has a first edge and a second edge and the second portion has a first edge and a second edge, and wherein the second edge of the first portion is connected substantially perpendicularly to the first edge of the second portion.

19. The door latch system of claim 17, and further comprising a clip mountable to the door, wherein the clip is engagable with the spring form.

20. The door latch system of claim 19, wherein the clip has a first end portion, a center portion, and a second end portion, wherein the center portion has a first edge and a second edge, and wherein the first end portion is substantially perpendicularly connected to the first edge of the center portion and the second end portion is substantially perpendicularly connected to the second edge of the center portion.

21. The door latch system of claim 20, wherein the first end portion of the clip is engagable with the wing of the spring form.

22. The door latch system of claim 17, wherein the spring form is movable between a relaxed position and an actuated position.

23. The door latch system of claim 22, wherein the spring form is out of a path of the door when the spring form is in the relaxed position.

24. The door latch system of claim 22, wherein the spring form is engagable with the door when the spring form is in the actuated position.
